(19) United States
(12) Patent Application Publication
(10) Pub. No.: US 2008/0124102 A1
(43) Pub. Date: May 29, 2008

(54) IMAGE FORMING APPARATUS

(76) Inventors: Takenobu KIMURA, Tokyo (JP); Yotaro Sato, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/873,891

(22) Filed: Oct. 17, 2007

(30) Foreign Application Priority Data
Nov. 28, 2006 (JP) JP2006-319876

(51) Int. Cl. G03G 15/00; G03G 15/16; G03G 15/01

(52) U.S. Cl. 399/45; 399/296; 399/302

(57) ABSTRACT

An image forming apparatus, including an image forming section which forms a toner image on an image carrier, a primary transfer section which transfers the toner image formed by the image forming section on the image carrier from the image carrier to an intermediate transfer body, a secondary transfer section which transfers the toner image on the intermediate transfer body onto an image transfer material, an pre-secondary transfer electric discharging section which is located between the primary transfer section and the secondary transfer section to electrically discharge the toner image on the intermediate transfer body, and a control section which controls an output of the pre-secondary transfer electric discharging section, based on a smoothness of a surface of the image transfer material.

This application is based on Japanese Patent Application No. 2006-319876 filed on 28 Nov. 2006 with the Japanese Patent Office, the entire content of which is hereby incorporated by reference.

### FIELD OF THE INVENTION

The present invention relates to a copy machine, a printer, a facsimile and an image forming apparatus combining the same, employing an electro-photographic method, and in particular, to an image forming apparatus, having an intermediate transfer body, which outputs a color toner image onto the intermediate transfer body.

A color image forming apparatus, employing the above electro-photographic method, having the intermediate transfer body, is well known, in which a toner image, formed on a photoconductor serving as an image carrier, is transferred onto the intermediate transfer body, after which the toner image on the intermediate transfer body is transferred onto an image transfer material (which is called a paper sheet). In said color image forming apparatus, the toner images on the image carriers, charged to a predetermined polarity, are sequentially superposed on the intermediate transfer body by the electrostatic force, which is a primary transfer operation, after which the toner images on the intermediate transfer body are transferred together onto the transfer member by the electrostatic force, which is a secondary transfer operation.

On the image forming apparatus conducting the secondary transfer operation, the electrostatic charge amount of toner on the intermediate transfer body tends to vary, due to the number of the primary transfer operation or the environment. Accordingly, various image damage tends to occur during the secondary transfer operation, which is conducted from the intermediate transfer body to the transfer member.

Further, since the electrostatic charge amount of a single toner particle is nearly uniform, the electrical potential on the intermediate transfer body is determined by the amount of toner adhered on a predetermined area. Concerning the toner images on the intermediate transfer body of the color image forming apparatus, the electrostatic charging potential of a portion where plural color toners are superposed is greater than at a portion where a single color toner is adhered, so that the color image forming apparatus requires a greater transferring electrical field.

In order to correct such unevenness of the electrostatic charge amount of toner, Unexamined Japanese Patent Publication No. 11-143,255 discloses technology as the primary transfer operation, in which AC or DC corona charge is conducted on the toner image transferred onto the intermediate transfer body, whereby the electrostatic charge amount of toner is uniform. Further, Unexamined Japanese Patent Publication No. 2006-78,630 discloses technology in which in order to prevent unevenness of density due to insufficient transferring electrical charge which occurs when the amount of adhered toner is greater and the electrical potential of toner layer is greater, and also in order to prevent electrical discharge due to the increased transferring electrical charge, the toner image on the intermediate transfer body is electrically discharged prior to the secondary transfer operation.

That is, when the electrical potential varies on the intermediate transfer body after the primary transfer operation, various adverse effects to the image occur during the secondary transfer operation. Accordingly, in the above described Patent Documents, the toner image on the intermediate transfer body is electrically charged or discharged so that the charged amount of toner on the intermediate transfer body is uniform, to stably conduct the secondary transfer operation.

However, high quality transfer sheets, such as a coated sheet, being different from a normal sheet, tends to be used for POD (Print On Demand) usage requiring higher image quality. The high quality sheet, whose surface is coated with a coating member to be flat and smooth, is used for the POD usage, listed are a gloss coated sheet being very glossy, a gloss coated sheet being less glossy, and a gravure coated sheet being high smoothness. FIGS. 2(a) and 2(b) show the exaggerated differences between the surfaces of the normal sheet and the high quality sheet. FIG. 2(a) shows the surface of a normal sheet, while FIG. 2(b) shows the surface of high quality sheet, where it can be seen that smoothness characteristics of the surface of the two types of sheets differ. That is, the normal sheet includes thick portions and thin portions, if the electrical potential difference of an airspace becomes higher than the electric discharge starting voltage in the thin portion, electrical discharge occurs. If low transferring electrical field is applied to prevent the electrical discharge, in order to totally conduct the secondary transfer on the toner existing in the portion carrying many layers of toner, strong discharge must be applied onto the toner prior to the secondary transfer. However, the half-tone sections of the high quality transfer sheet having a lower amount of adhered toner become rough.

### SUMMARY OF THE INVENTION

An object of the present invention is to provide an image forming apparatus which can output image quality matching the smoothness characteristic of the sheet during the secondary transfer operation.

The above object can be attained by a structure described below.

An image forming apparatus including, an image forming section which forms a toner image on an image carrier, a primary transfer section which transfers the toner image formed by the image forming section onto an intermediate transfer section, and a secondary transfer section which transfers the transferred toner image onto an image transfer material, wherein the image forming apparatus further includes a pre-secondary transfer electric discharging section which is located between the primary transfer section and the secondary transfer section to electrically discharge the toner image on the intermediate transfer body, and a control section which controls an output of the pre-secondary transfer electric discharging section based on the smoothness characteristic of the surface of the image transfer material.

### BRIEF DESCRIPTION OF THE DRAWINGS

FIG. 1 shows an image forming apparatus relating to an embodiment of the present invention.

FIGS. 2(a) and 2(b) show an exaggerated difference between the surfaces of normal paper sheets and high quality sheets.

FIG. 3 is an enlarged drawing of a scorotron electrode and its vicinity, shown in FIG. 1.

FIG. 4 is a block diagram of an electrical control system.

FIGS. 5(a) and 5(b) are flow charts showing the procedure for setting the pre-secondary transfer electric discharging operation prior to the secondary transfer operation, based on the smoothness characteristic of the surface of the image transfer material.

FIG. 6 shows an apparatus used for the experimental tests.

### DETAILED DESCRIPTION OF THE INVENTION

The embodiment of the present invention will now be detailed, however the present invention is not to be limited to the embodiment detailed below.

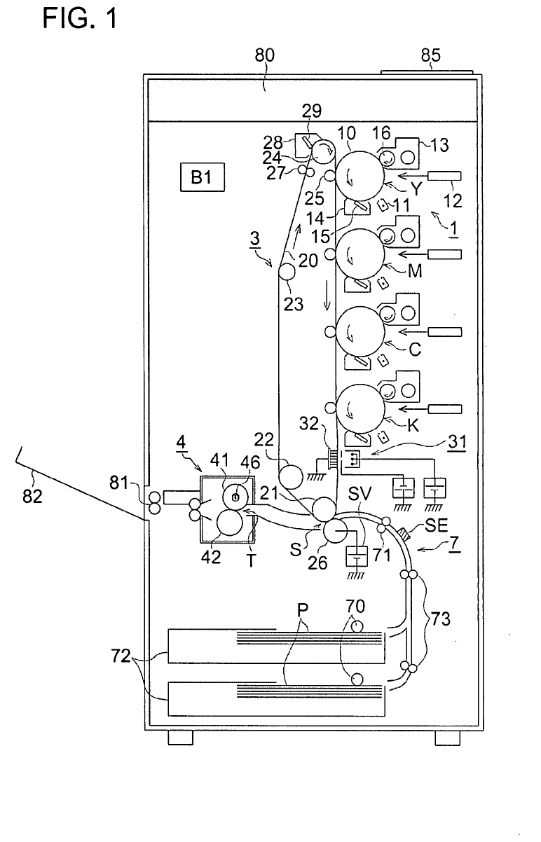

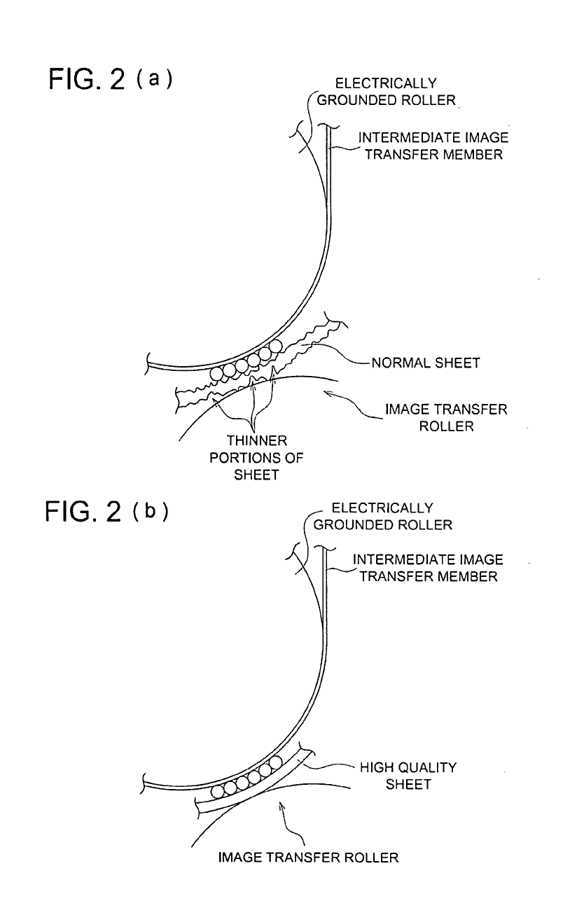

FIG. 1 shows the image forming apparatus relating to the embodiment of the present invention.

In FIG. 1, the image forming apparatus includes photo-conductor 10 being an image carrier, scorotron charger 11 being an electrical charging device, writing device 12 being an exposure device, developing device 13, cleaning device 14 to clean the surface of photo-conductor 10, cleaning blade 15, developing sleeve 16, and intermediate transfer belt 20 being the intermediate transfer body.

Image forming section 1 is structured of photo-conductor 10, scorotron charger 11, writing device 12, developing device 13 and cleaning device 14.

Since the mechanical structure of image forming section 1 for each color is the same, the numerals in FIG. 1 are attached only for the yellow Y forming system, and the numerals are omitted for magenta M, cyan C, and black K.

Image forming sections 1 of Y, M, C and K are arranged in that order along the conveyance direction of intermediate transfer belt 20. Each photo-conductor 10 comes into contact with the surface of intermediate transfer belt 20, and rotates in the same direction and the same line speed as intermediate transfer belt 20 at each contacting point.

Intermediate transfer belt 20 is entrained about driving roller 21 being an electrically grounded roller, conveyance roller 22, tension roller 23 and driven roller 24. Belt unit 3 is structured of said rollers, intermediate transfer belt 20, transfer roller 25, being the primary transfer section, and cleaning device 28.

Intermediate transfer belt 20 is driven by drive roller 21 which is activated by a drive motor, which is not illustrated.

Photoconductor 10 is formed of a cylindrical metallic member whose surface is covered with an electrical conducting layer, such as a-Si layer, or a photoconductive layer, such as an organic photo conductor (OPC). Photoconductor 10 whose electrical conducting layer is electrically grounded, rotates counterclockwise as shown by the arrows in FIG. 1.

Electrical signals corresponding to the image data coming from reading section 80 are converted to optical signals by image forming laser rays, after which the optical signals are exposed onto photoconductor 10 by writing device 12.

Developing device 13 has cylindrical developing sleeve 16 which is formed of nonmagnetic stainless or aluminum, installed at a predetermined position separated from the surface of photoconductor 10, and rotates in the same line direction as photoconductor 10.

Endless intermediate transfer belt 20, exhibiting 10⁶-10¹² volume resistivity, and 0.04-0.10 mm thickness, is a seamless semiconductor belt, having an electrically conductive member which is dispersed on an engineering plastics, such as denaturated polyimide, hot cured polyimide, ethylenetetrafluoroethylene copolymer, poly-vinylidene fluoride, and a nylon composition.

Transfer roller 25, having applied direct current voltage with an opposite polarity of the toner image, transfers the toner image formed on photoconductor 10 onto intermediate transfer belt 20. A corona discharger as the primary transfer section can be used instead of the transfer roller.

Transfer roller 26 serves as a secondary transfer section, which is capable of contacting or retracting from intermediate transfer belt 20 driven by electrically grounded drive roller 21, and transfers the toner image formed on intermediate transfer belt onto image transfer material P being a recording sheet.

Cleaning device 28 opposes driven roller 24, which sandwich intermediate transfer belt 20 between them. After the toner image is transferred onto image transfer material P, intermediate transfer belt 20 is electrically discharged by charge discharging roller 27, on which the AC voltage, superposed with the DC voltage being the same polarity as the toner or opposed polarity to the toner, is applied, so that the electrical charge of the remaining toner is reduced, and cleaning blade 29 mechanically removes any residual toner remaining on intermediate transfer belt 20.

Scorotron electrode 31 serves as a charging section or a discharging section prior to the secondary transfer operation.

Electrically grounded brush electrode 32 opposing scorotron electrode 31 comes into contact with the inner surface of intermediate transfer belt 20.

Scorotron electrode 31 will be detailed later.

By nip section T of fixing device 4, which is structured of heating roller 41, pressure applying roller 42, and halogen heater 46, fixes the image transferred onto transfer member P on which the secondary transfer operation has been conducted by nip section S, structured of transfer roller 26 and drive roller 21.

In the vicinity of conveyance path 7, provided are sheet pick-up roller 70, paired timing rollers 71, sheet cassettes 72 and paired conveyance rollers 73.

Reflection optical sensor SE relating to the present invention detects the smoothness characteristic of the surface of transfer member P which is conveyed through conveyance path 7.

Paired sheet ejection rollers 81 eject transfer member P, carrying the fixed image, onto tray 82, operation panel 85 is mounted on the top surface of the image forming apparatus.

Control section B1 controls the image forming process, the conveyance of the image transfer material, the fixing temperature, and the output to be outputted from the pre-secondary transfer electric discharging section prior to the secondary transfer operation (hereinafter referred to as “pre-discharge”).

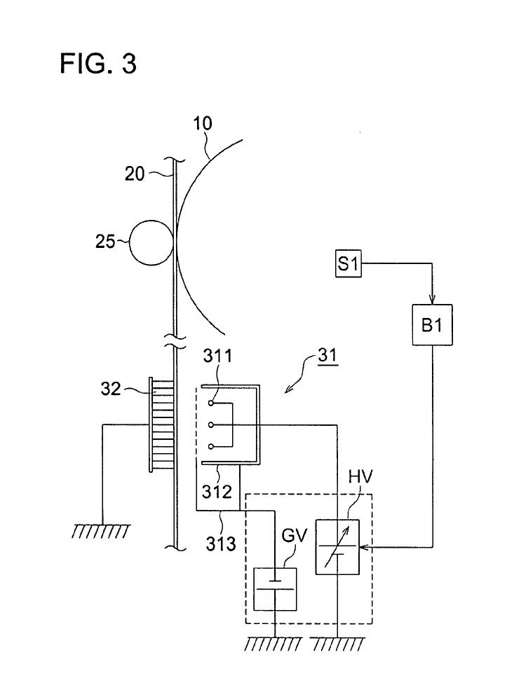

Next, the pre-discharging operation, which is to be conducted onto the toner image on the intermediate transfer belt prior to the secondary transfer operation, will now be detailed while referring to FIG. 3.

FIG. 3 is an enlargement of scorotron electrode 31 and its vicinity shown in FIG. 1.

In FIG. 3, scorotron electrode 31 is structured of tungsten wires 311, side plate 312 and grid electrode 313. Electrically conductive acryl brush electrode 32 is mounted inside intermediate transfer belt 20 to oppose scorotron electrode 31 so that brush electrode 32 softly comes into contact with the inner surface of intermediate transfer belt 20.

As described above, when the pre-discharging operation is conducted onto the toner image formed on intermediate transfer belt 20 by scorotron electrode 31 mounted upstream of the secondary transfer section being transfer roller 26, if scorotron electrode 31 outputs higher electrical potential onto any portion carrying many layers of different color toner to conduct predetermined volume of discharge, electrical discharge of any portion carrying only a single layer of toner becomes too great, whereby the image quality becomes low (being a rough image) during the secondary transfer operation, resulting in unacceptable prints.

That is, concerning a normal sheet (being a standard sheet) having a rough surface (see FIG. 3(a)), since thinner portions exist in the normal sheet, electrical discharge tends to occur there due to the electrical potential difference between both surfaces of the sheet during the secondary transfer operation, whereby it is impossible to set greater transferring electrical field. In order to transfer all the toner of the portions carrying a large amount of adhered toner, greater discharge must be applied onto the toner to enable transfer of the toner under the lower transferring electrical field. On the other hand, since the electrical discharge due to the electrical potential difference between both surfaces of the sheet tends not to occur in the high quality sheet (such as a coated sheet), for which it is possible to set the greater transferring electrical field, whereby the toner of the portions carrying a large amount of adhered toner can be transferred onto the high quality sheet, by lower discharging output than the case of the normal sheet. By reducing the output of the pre-discharge, the roughness (being deterioration of the image) of the half-tone section is controlled so that the high quality image can be obtained regardless of the image density.

That is, since the optimum value of the discharging condition for both a high quality sheet and a normal sheet has been obtained, when the output of the pre-discharge is applied based on the smoothness of the surface of the transfer member, suitable image quality corresponding to the use can be obtained.

In the present invention, based on the type of transfer members (which is the smoothness characteristic of the surface of the transfer member), high voltage output during the pre-discharge conducted by the scorotron electrode is controlled so that the deterioration of the image quality is prevented.

That is, from the relationship between the smoothness of the surfaces of transfer member and the desired image quality, and from the relationship between the smoothness of the surfaces of transfer member and the degree of occurrence of uneven transference on portions carrying a large amount of adhered toner, an optimum value of the output of the pre-discharge differs based on the type of transfer members. When a transfer member having smooth surfaces is used, the output of the pre-discharge is controlled to be small, while when a transfer member having rough surfaces, such as a normal sheet, is used, the output of the pre-discharge is controlled to be large so that toner transference of portions carrying a large amount of adhered toner is improved, whereby image quality matched to the transfer member can be obtained. That is, by such control, in cases that the transfer member having the very rough surfaces is used under the pre-discharge condition of the transfer member having the very smooth surfaces, uneven toner transference of the portions carrying a large amount of adhered toner due to insufficient discharging output is prevented. Further, in cases that the transfer member having the very smooth surface is used under the pre-discharge condition of the transfer member having the very rough surfaces, preferable toner transference of the portion carrying the small amount of adhered toner is obtained. Accordingly, the above-described two cases can preferably co-exist.

In the present embodiment, reflection optical sensor SE, serving as an detector of the sheet surface condition, is mounted on conveyance path 7. The smoothness characteristic of the surface of the transfer member is detected by the amount of reflected light rays, which is transmitted to control section B1. Control section B1 determines whether a conveyed sheet is a high quality sheet of very smooth surfaces or a normal sheet of rough surfaces, based on predetermined standards. Control section B1 instructs variable high tension power supply HV to output the electrical output (voltage or current) corresponding to the type of transfer member, based on set programs of the output of the pre-discharge, stored in control section B1.

Further, a surface smoothness detection section can be installed near the surface of the sheet on sheet cassette 72, which is a sheet supplying tray. Said detection section is connected to control section B1 so that the output of the pre-discharge can be selected based on the detected smoothness of the surface of the transfer member. Accordingly if the operator selects the type of sheets via operation panel 85, the output of the pre-discharge suitable for various sheets can be automatically selected.

In the present invention, scorotron electrode 31 is mounted between K (being black) image forming section 1 as the last of four sections and transfer roller 26. Two types of high voltages, +3 kV and +5 kV, are applied onto discharging wires 311 from variable high tension power supply HV. Negative voltage of −50V, is applied onto grid electrode 313. The same potential as grid electrode 313 is allied onto side plate 312. Brush electrode 32 is electrically grounded. The clearance between grid electrode 313 and intermediate transfer belt 20 is 1 mm. The width of scorotron electrode 31 and brush electrode 32 is typically 30 mm. Concerning the scorotron electrodes, a needle-type electrode can be used instead of the discharging wires.

When the smoothness characteristic of the surface of the transfer member is high, the lower output is set onto the transfer roller serving as the secondary transfer section, than when the smoothness characteristic of the surface of the transfer member is low. In detail, when the output applied onto the transfer roller is controlled by the electrical current, a normal sheet is controlled by 10-15 μA less current than a high quality sheet. Further, based on the apparatus' ambient environment, such as humidity, and the condition of the image to be formed, a normal sheet is preferably controlled by a scope at 15-45 μA, while a high quality sheet is preferably controlled by a scope at 25-55 μA.

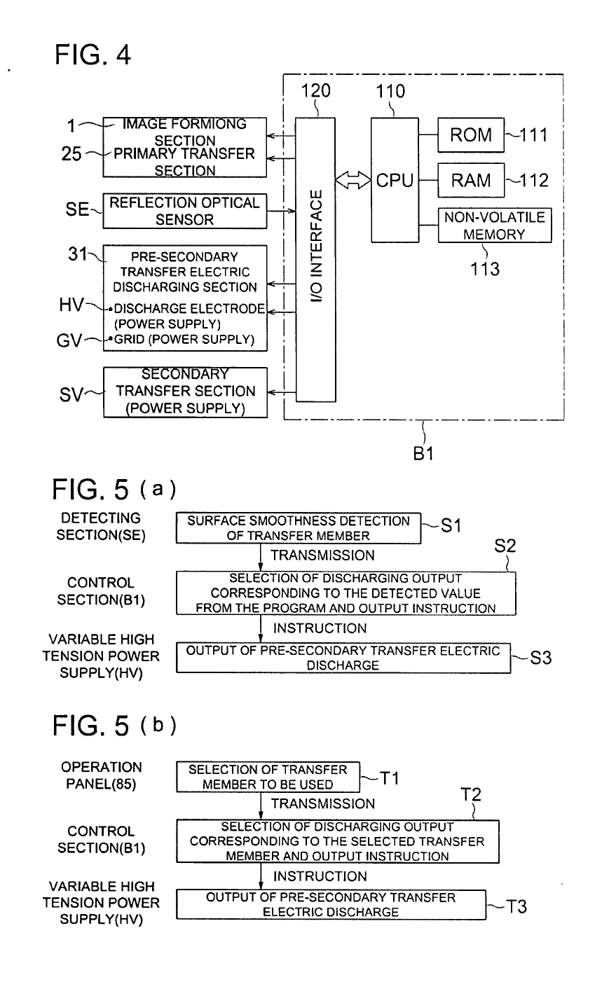

FIG. 4 is a block diagram of an electrical control system.

In FIG. 4, ROM 111, RAM 112, and non-volatile memory 113 are connected to CPU 110. Operating basic data, image forming mode programs, and set programs of the output of the pre-discharge are stored in ROM 111. A look-up table for setting the pre-discharge condition is stored in non-volatile memory 113. CPU 110 is typically connected to external devices, such as a high tension power supply, via interface 120.

Reflection optical sensor SE, serving as the detecting section of the smoothness characteristic of the surface of the transfer sheet, is connected to the input port of interface 120. The image forming section, high tension power supply HV for discharging wires 311 of the pre-secondary transfer electric discharging section, power supply GV for grid 313, and power supply SV for paired transfer rollers 26 are connected to the output ports of interface 120.

On the image forming apparatus shown in FIG. 1, an operation and displaying section is provided, on which the operator inputs the size of sheet and the desired number of prints, and then depresses the start button to instruct the start of the printing operation. CPU 110 retrieves the image forming mode program from ROM 111, and conducts image formation for the set number of prints based on the image data stored in the memory.

The voltage to be applied to grid electrode 313 is inputted by the service person when the image forming apparatus is installed.

FIGS. 5(a) and 5(b) are flow charts showing the procedure for setting the output of the pre-discharge, based on the smoothness of the surface of the transfer member.

When a output of the pre-discharge is set after the smoothness of the surface of the transfer member is detected on conveyance path 7, reflection optical sensor SE (being a detecting section) detects the smoothness of the surface of transfer member P on conveyance path 7 in step S1. Control section By selects a output of the pre-discharge from the set programs, based on the detected value of the smoothness of the surface of the transfer member in step S2. In step S3, control section B1 instructs variable high tension power supply HV to output a selected output of the pre-discharge.

Next, when a output of the pre-discharge is selected at a transfer member selection mode, the operator selects a transfer member on the operation panel in step T1. In step T2, set is the output of the pre-discharge of the transfer member, which was selected by the set programs of the type of transfer member previously stored in control section B1 and the output of the pre-discharge. In step T3, control section B1 instructs variable high tension power supply HV to output the set output of the pre-discharge.

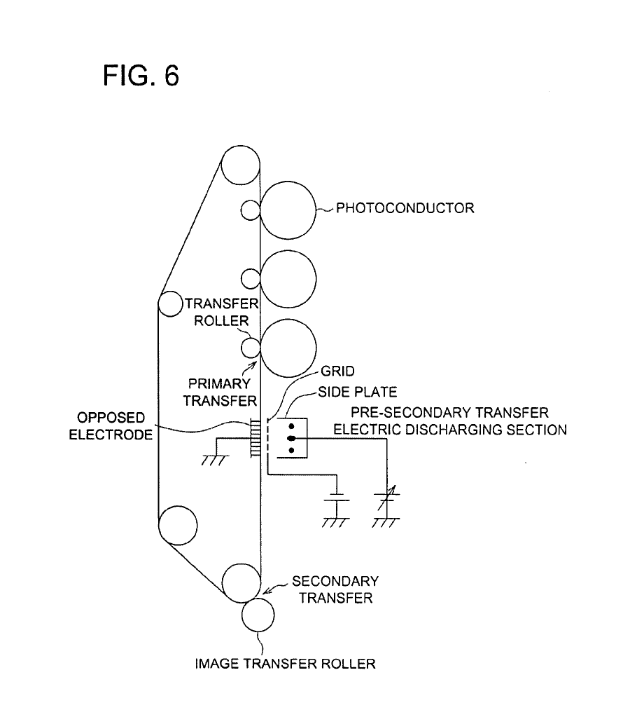

In order to confirm the targeted effects of the present embodiment, the inventor of the present invention carried out an experimental tests, while using the apparatus shown in FIG. 6.

FIG. 6 shows the apparatus used for the experimental tests.

### Experiments

### [Experimental Conditions]

Apparatus: Tandem-Type Color Image Forming Apparatus

(see FIG. 1)

Intermediate transfer belt:
The belt is made of polyimide, at a volume resistance 10⁹Ω, a surface resistance of 10¹¹Ω, and a belt tension of 39.2 N.

Pre-secondary transfer electric discharging device (Scorotron electrode as a electrical neutralizer, operating before the second transfer operation):
An electrode being the same type as the scorotron electrode is installed on the spaces from which the photoconductor of the fourth image forming apparatus (operating for black color K) and the developing device are removed (see FIG. 6). The voltage applied on the discharging wires can vary from 0 to 7 kV, the grid electrode is −50V, the side plate is the same electrical potential as the grid electrode, the width of pre-secondary transfer electric discharging device is 30 mm, while the length is 320 mm, and the clearance between the grid electrode and the intermediate transfer belt is 1 mm.

Opposing electrode is an electrically conductive acryl brush at an electrical resistance of the original yarn is 10²Ω, the yarn diameter is 3d, the density is 31 kF/cm², and yarn length is 4 mm.

Opposing electrode slightly contacts the inner surface of the transfer belt at 294 Pa/cm². The brush width is 30 mm and the length is 320 mm, being electrically grounded.

### [Image Quality Checking Test]

After image forming tests were conducted for several sheets, the image quality of two evenly layered toner images and half tone image were checked, the experimental results are shown in Table 1. Symbol “A” means that the image quality formed on the coated sheet (for POD use) is acceptable, symbol “B” is not acceptable for POD, but acceptable for normal sheets, and symbol “C” means that the image quality is not acceptable, due to an irregularly formed image.

TABLE 1

| | | Outputted | Two | | |
|---|---|---|---|---|---|
| | | voltage | evenly | | |
| | | from the | layered | Half- | |
| | Type of the | discharging | toner | tone | |
| | sheets | wire | images | image | Results |
| Practical | Coated sheet | 3 kV | A | A | OK |
| example | (For POD use) | | | | |
| | Normal sheet | 5 kV | B | B | NG |
| | (Standard | | | | |
| | sheet) | | | | |
| Comparative | Coated sheet | 3 kV | A | A | OK |
| example 1 | (For POD use) | | | | |
| | Normal sheet | 3 kV | C | A | NG |
| | (Standard | | | | |
| | sheet) | | | | |
| Comparative | Coated sheet | 5 kV | A | B | NG |
| example 2 | (For POD use) | | | | |
| | Normal sheet | 5 kV | B | B | OK |
| | (Standard | | | | |
| | sheet) | | | | |

### [Valuation Result]

Practical example: For the coated sheet (POD use), the quality of the two evenly layer toner images and the half-tone image were determined to be “A” at 3 kV discharge. For “normal” sheets, the quality of the two evenly layer toner images and the half-tone image were determined to be “B” at 5 kV discharge.

### COMPARATIVE EXAMPLE 1

For the coated sheet, the quality of the two evenly layer toner images and the half-tone image were determined to be “A” at 3 kV discharge. However, for the quality of normal sheets (standard sheet), the half-tone image was determined to be “A”, while the quality of the two evenly layer toner images was determined to be “C” at 3 kV discharge.

### COMPARATIVE EXAMPLE 2

For the coated sheet, the quality of the two evenly layer toner images was determined to be “A”, while the quality of the half-tone image was determined to be “B” by 5 kV discharge, that is, the image quality as a POD was not satisfied. For the normal sheets (standard sheet), the quality of the two evenly layer toner images and the half-tone image were determined to be “B”, which was an acceptable image quality level.

Accordingly, as shown in the practical example, the output of the pre-discharge is controlled to be lower for the coated sheet used for POD (namely 3 kV), while the output of the pre-discharge is controlled to be higher for the normal sheet having the rough surfaces (namely 5 kV), whereby the acceptable image quality, determined as “A”, can be obtained. However, as shown in comparative examples 1 and 2, a single setting of the output of the pre-discharge, either 3 kV or 5 kV, cannot produce image quality to satisfy both coated sheets and normal sheets.

As to the effect of this invention, the pre-secondary transfer electric discharging which fits in well with the smoothness characteristic of the surface of the transfer sheet, can prevent unacceptable image quality, while conducting stable secondary image transfer onto the image transfer media.

What is claimed is:

1. An image forming apparatus, comprising:
an image forming section which forms a toner image on an image carrier,
a primary transfer section which transfers the toner image formed by the image forming section on the image carrier from the image carrier to an intermediate transfer body,
a secondary transfer section which transfers the toner image on the intermediate transfer body onto an image transfer material,
a pre-secondary transfer electric discharging section which is located between the primary transfer section and the secondary transfer section to electrically discharge the toner image on the intermediate transfer body, and
a control section which controls an output of the pre-secondary transfer electric discharging section based on a smoothness characteristic of a surface of the image transfer material.

2. The image forming apparatus of claim 1, further comprising a detecting section which detects the smoothness characteristic of the surface of the image transfer material.

3. The image forming apparatus of claim 1, wherein the detecting section is mounted on a conveyance path of the image transfer material, or mounted in an adjacent portion of a tray to supply the image transfer material.

4. The image forming apparatus of claim 1, wherein corresponding to an input of a type of the image transfer material, the output of the pre-secondary transfer electric discharging section is enable to be controlled based on the smoothness characteristic of the surface of the image transfer material corresponding to the type.

5. The image forming apparatus of claim 1, wherein when the smoothness characteristic of the surface of the image transfer material is lower, the output of the pre-secondary transfer electric discharging section is set to be reduced than a case that the smoothness characteristic is higher.

6. The image forming apparatus of claim 1, wherein the pre-secondary transfer electric discharging section is a scorotron electrode having a grid electrode.

7. The image forming apparatus of claim 4, wherein when the smoothness characteristic of the surface of the image transfer material is higher, the output of the secondary transfer section is set to be lower than a case that the smoothness characteristic of the surface is lower.
